(19) United States
(12) Patent Application Publication
(10) Pub. No.: US 2012/0151337 A1
(43) Pub. Date: Jun. 14, 2012

(54) SYSTEM AND METHOD FOR ORGANIZING USER INTERFACE FOR PERIODICALS

(76) Inventors: MATT PALLAKOFF, Mountain View, CA (US); Jeff Tycz, Palo Alto, CA (US); Jennifer Ng, San Francisco, CA (US); Josh Feldman, San Francisco, CA (US); Laurie Vertelney, Palo Alto, CA (US)

(21) Appl. No.: 13/272,124

(22) Filed: Oct. 12, 2011

Related U.S. Application Data
(60) Provisional application No. 61/406,646, filed on Oct. 26, 2010.

(51) Int. Cl. G06F 3/14; G06F 17/00

(52) U.S. Cl. 715/273

(57) ABSTRACT

A system and method for displaying periodical digital content. A device sorts and organizes the periodical content stored on the device according to the title of the periodical and further according the dates of the periodicals. Each periodical, e.g., newspapers and magazines, after sorting, are displayed on the device's user interface on its own virtual shelf according to the periodical, and then preferably in chronological order within the shelf that is dedicated to the periodical. Alternatively, the periodicals are sorted by issue date, and virtual shelves are dedicated specific date ranges, e.g., “Today,” “This Week,” “This Month.”

### CROSS REFERENCE TO RELATED APPLICATION

This application claims benefit under 35 U.S.C. §119(e) from U.S. Provisional Patent application No. 61/406,646, filed on Oct. 26, 2010, the entirety of which is incorporated by reference herein.

### FIELD OF THE INVENTION

The present invention generally relates to systems and methods for organizing user interfaces, and more particularly to systems and methods for organizing a user interface on a mobile electronic book reader to properly display periodicals.

### SUMMARY OF THE INVENTION

The virtual periodical shelf of the present invention is a user interface metaphor that organizes the display of the periodical content stored in an electronic-reader user's library in an intuitive manner. Specifically, any periodicals, e.g., newspapers and magazines, that are stored in the user's virtual library, or “locker,” are displayed on the electronic reader's user interface on its own shelf according to the periodical, and then preferably in chronological order within the shelf that is dedicated to the periodical.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a system according to the present invention;

FIG. 2 illustrates the process of the present invention;

FIG. 3 depicts a preferred user interface;

FIG. 4 illustrates an alternative sorting and display method; and

FIG. 5 illustrates an exemplary local device.

### DETAILED DESCRIPTION OF THE INVENTION

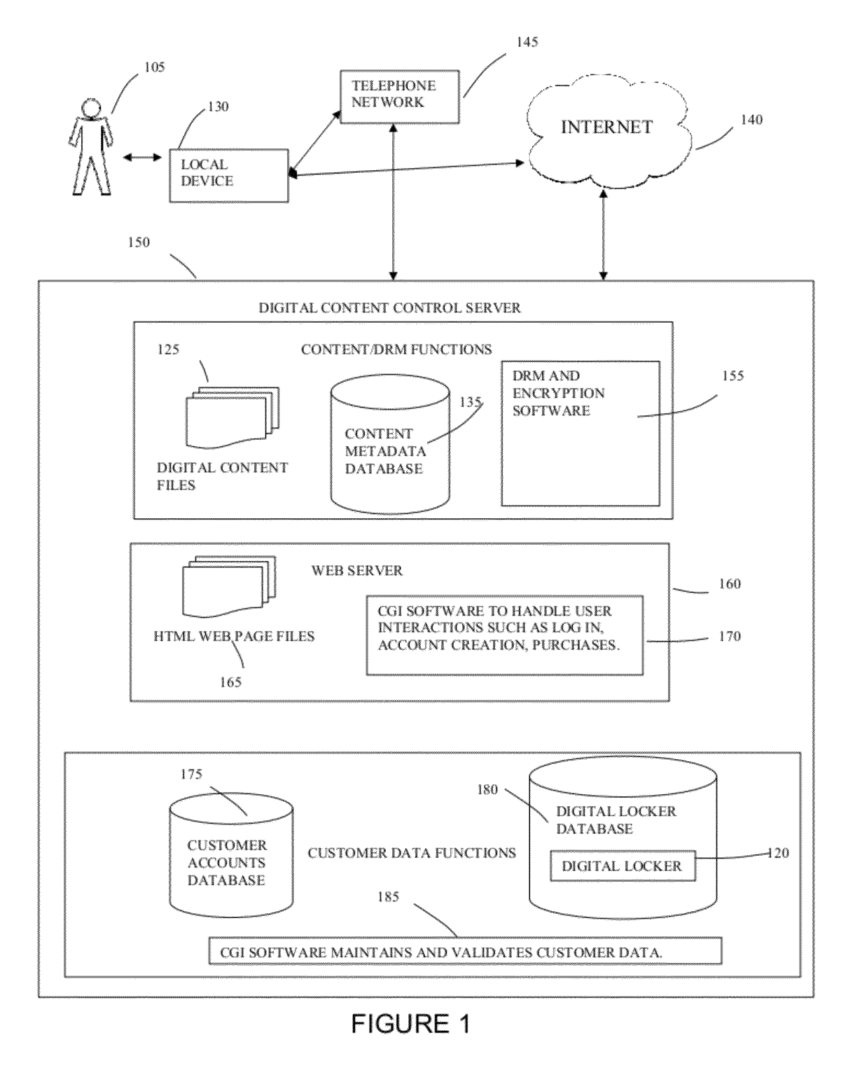

FIG. 1 shows components of digital content control system according to the present invention. User 105 is an authorized user of the digital content control system of the present invention. Many of the functions of digital content control system are carried out on digital content control server 150. As appreciated by those skilled in the art, many of the functions described herein can be divided between the digital content control server 150 and the user's local device 130. Further, as also appreciated by those skilled in the art, digital content control server 150 can be considered a “cloud” with respect to the user 105 and his local device 130. The cloud can actually be comprised of several servers performing interconnected and distributed functions. The user 105 can connect to the digital content control server 150 via the Internet 140, a telephone network 145 (e.g., a wireless cellphone network) or other suitable electronic communication channels. User 105 has an account on digital content control server 150, which authorizes user 105 to use the digital content control system.

Associated with the user's 105 account, is the user's 105 digital locker 120 located in a Digital Locker Database 180 on the digital content control server 150. As further described below, in the preferred embodiment, digital locker 120 contains links to copies of digital content 125 purchased or otherwise legally acquired by user 105.

Indicia of rights to all copies of digital content 125 owned by user 105 are stored by reference in digital locker 120. Digital locker 120 is a remote online repository that is uniquely associated with the user's 105 account. As appreciated by those skilled in the art, the actual copies of the digital content 125 purchased by user 105 are not necessarily stored in the user's locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users 105 who have purchased a copy of a particular digital content 125 would point to this copy in mass storage. Of course, back up copies of all digital content 125 are maintained for disaster recovery purposes.

Although only one example of digital content 125 is illustrated in this Figure, it is appreciated that the digital content control server can contain millions of files 125 containing digital content. It is also contemplated that the digital content control server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 105 can access his or her digital locker 120 using a local device 130. Local device 130 is an electronic device such as a personal computer, an eBook reader, a smart phone or other electronic device that the user 105 can use to access the digital content control server 150. In a preferred embodiment, the local device 130 has been previously associated or registered with the user's 105 account using user's 105 account credentials. Local device 130 provides the capability for user 105 to download the user's copy of digital content 125 via his or her digital locker 120. After digital content 125 is downloaded to local device 130, user 105 can engage with the downloaded content locally, e.g., read the book, listen to the music or watch the video.

In a preferred embodiment, local device 130 includes a non-browser based user interface subsystem that allows user 105 to initiate the purchase of digital content 125 in a non-browser environment. Through the device interface, the user 105 is automatically connected to the digital content control server 150 in a non-browser based environment. This connection to the digital content control server is a secure interface and can be through the telephone network 145, typically a wireless cellular network for mobile devices. If user 105 is accessing his or her digital locker 120 using the Internet 140, local device 130 also includes a web account user interface subsystem. Web account interface provides user 105 with browser-based access to his or her account and digital locker 120 over the Internet 140. Web interface allows user 105 to initiate the purchase of digital content 125 in a browser based environment. Local device 130 further includes an input output subsystem that provides the interface between the local device 130 and the remote server 150. Local device 130 also includes an operating system that is operable to control the operations of the local device 130.

FIG. 1 further illustrates the detailed components of digital content control server 150. Digital content control server 150 handles front-end functions related to web server operations and user interactions with the web and device interfaces in connection with the user's local devices 130. Digital content control server 150 also handles all backend functions related to managing accounts, maintaining digital locker records, maintaining content metadata and providing encryption services.

Digital content control server 150 provides both the browser based web interface and the non browser based device interface. User 105 may engage with the web interface or the device interface to initiate a purchase.

Digital content control server 150 employs web server 160 including web services interface software 170 to handle interactions between front-end components, such as device interface, web account interface, and web interface, and back-end database components of the system. Web server 160 services include serving up the web pages 165 that comprise the web account interface and the web interface, and the underlying web services associated with the device interface. Web services interface software 170 includes handling users' logins to their accounts and processing the initiation of and response to purchase requests.

Back-end database components of digital content control server 150 includes customer accounts database 175, digital lockers database 180, and content metadata database 135. Records for users' accounts are stored and managed in customer accounts database 175. Records for digital lockers 120 are stored and managed in digital lockers database 180. Content metadata database 135 serves as a source of metadata for individual digital content items 125 in digital content control server 150.

Web services interface software 170 in the web server 160 interfaces with customer data services 185 to update customer accounts database 175 and digital lockers database 180. Customer data services 185 processes database updates such as maintaining and validating customer data in users' accounts. Web services interface software 170 in the web server 160 also interfaces with content encryption services 155 to secure certain communications with local device 130 and to package digital content 125 for secure delivery to user 105.

In the preferred embodiment of the invention, digital content control server 150 is an eBook and periodical digital content control system. Although the eBook and digital periodical applications are the preferred embodiment, as appreciated by those skilled in the art, the digital content control server 150 of the present invention is not limited to user 105 purchasing and using eBooks or digital publications. Digital content control server 150 can be used for purchase and use of any digital content, such as digital movies, digital music, digital audio books, digital pictures or other downloadable digital content.

In the preferred embodiment of the invention, local device 130 is a mobile electronic reader (eReader) device. The embodiment of the invention is not intended to limit local device 130 to a mobile eReader device. Local device 130 may be a desktop personal computer or another type of mobile consumer electronic device, such as, for example, a cell phone, a laptop computer, a tablet computer or other mobile digital device.

The virtual periodical shelf of the present invention is a user interface metaphor that organizes the display of the periodical content contained within a user's library in an intuitive way such that any object in the user's virtual library, or “locker,” that is periodical in nature, including, but not limited to, for example, newspapers and magazines, is displayed on its own shelf in the user interface on the local device 130.

In its preferred implementation, this organizational capability is a subsystem of an electronic reader software application, such as a Library application, which serves as an interface for users to display the content available on or through their devices. Most such applications today present e-reader contents in an order that does not take into account media object types.

Conventional portable devices provide sequential lists or grids of all of the contents, e.g., books, magazine, newspapers, digital music files, and digital video files, available for use on the portable digital devices, without regard to the specific natures of the files. For example, a digital music file could be positioned in the list with a newspaper file immediately before and after it. In other cases, weeks or months of periodical issues from various publishers could be listed in one long list, sorted by title or issue date. While these methods of presentation are sufficient for some media types, they are not intuitive or efficient ways to organize periodicals. The current invention is designed specifically to address these deficiencies.

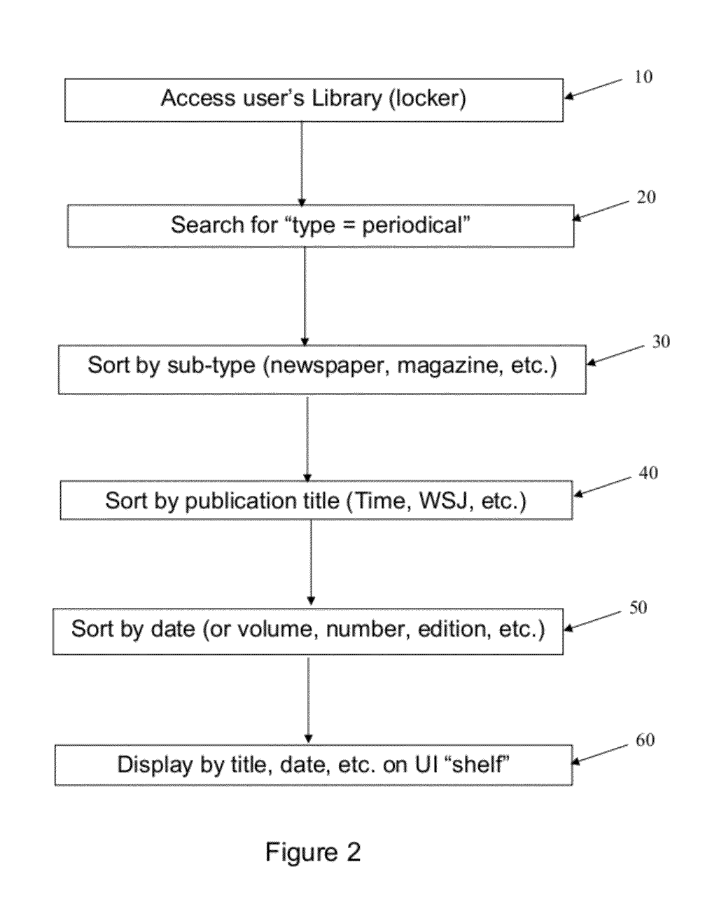

Referring to FIG. 2, in the preferred implementation, the present invention is implemented by a software subsystem comprised of various steps that, in total, survey the stored contents available to an electronic reader, and perform the operations necessary to support a representational display of those contents. In the preferred embodiment the periodicals are presented on one shelf per title, with the individual issues of each periodical arrayed by date.

In step 10, the process determines all of the available digital content by accessing the total contents of the device's 130 Library. The device's 130 Library can include digital content 125 that is stored local to the device 130 and can also include digital content 125 that is remotely stored on the digital content control server 150, but accessible by the device 130, e.g., through the Internet 140 or other suitable communication channel such as the telephone network 145. As most devices 130 have limits to their storage capabilities, in a preferred embodiment, permanent copies of digital content 125 owned by the user 105 are stored on the server 150 as described above.

In step 20 it is determined which of the digital content 125 in the user's library is of a periodical type, e.g., a newspaper or magazine. Each of the digital content 125 contains metadata that identifies the type and subtype of the digital content 125.

In step 30 the above determined periodical type digital content are then sorted by sub-type, where sub-types will include newspapers and magazines, but may also include other types of objects such as academic journals, newsletters, or other materials characterized by sharing a similar title and being published on a regular and recurring basis.

In step 40, the sorted digital content are further sorted by title, and in step 50 further sorted by date, although other types of sorts are definable by the user 105.

In step 60, the finally sorted digital content is displayed to the user 105 with each publication being displayed on its own virtual shelf on the user interface on device 130. For example, there may be a Fine Cooking magazine shelf, a Real Cooking magazine shelf, a Traveler magazine shelf, and so on.

On any given virtual shelf, the individual issues for that periodical type digital content 125 are preferably listed chronologically, left to right, with most recent issues to the left and older issues to the right.

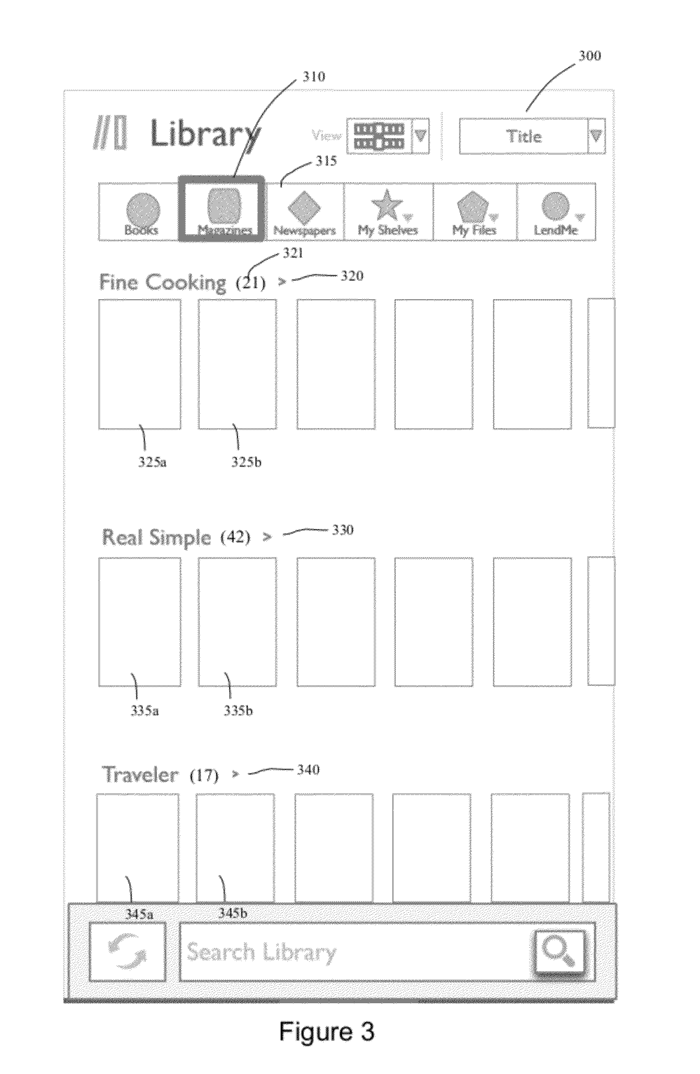

A preferred user interface (UI) 300 presented on the user's local device 130 is depicted in FIG. 3. In the example illustrated in FIG. 3, the user 105 has selected to view her magazine periodicals. The user 105 selects this by tapping, touching, or clicking on button 310 on user interface 300. If the user 105 wanted to view her newspaper periodicals, she would tap on button 315.

As shown in this snapshot of the user interface 300, three separate magazine periodicals on three separate virtual shelves are displayed: Fine Cooking magazine 320, Real Cooking magazine 330; and Traveler magazine 330. Although only three periodicals are illustrated in the snapshot of user interface 300 in FIG. 3, all of the periodicals owned by the user 105 can be seen on the interface 300. The user 105 can scroll the display of shelves vertically to find the shelf holding the publication of interest. Further, the user can scroll the display horizontally to find the issue of a particular periodical that is of interest.

As shown in FIG. 3, the number, 321, 331, 341 in parentheses next to the title of the periodical shows how many issues are on that shelf for that periodical, 320, 330, 340.

In the preferred implementation, as described above, the issues on a shelf are organized from left to right in descending chronological order. For example, issues 325a, 335a and 340a have a later issue date than issues 325b, 335b and 340b. Preferably the date of each issue is displayed below the cover for that issue. Also preferably, the blank boxes shown in FIG. 3, e.g., 325a, are thumb-nail pictures of the actual covers for the issues of the periodicals. In order to read a particular issue, the user simply taps on the thumbnail icon, e.g., 325a, and the device 130 launches the appropriate reader application and opens the periodical digital content issue for reading. If the selected issue is not stored on the local device 130, the device automatically contacts the server 150, and the archived copy of the issue is downloaded to the device 130 for reading.

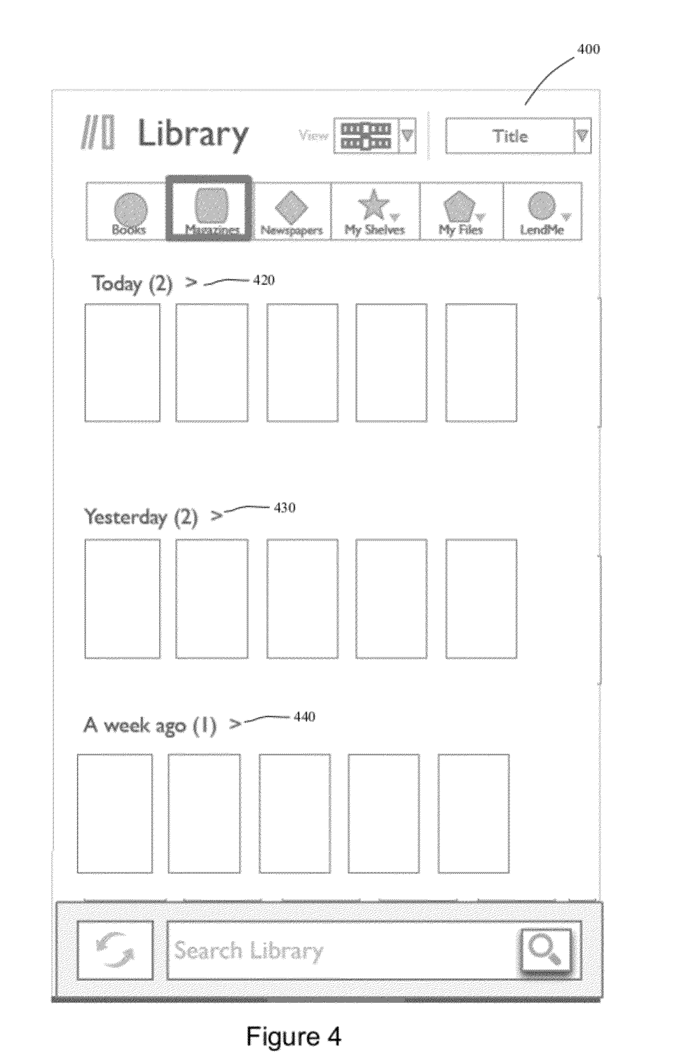

Alternative versions of the present invention can be derived by altering the sequence of steps in FIG. 2. For example, it would be possible to have a shelf for each month of the year, and put all magazines that arrive in a given month, say April, on the “April shelf,” irrespective of the titles of those magazines. This alternative could also be applied to weeks or days, so that all newspapers arriving on a given day could be found on a single shelf. If no issues arrived on a given day, that shelf can be left out of the user interface display. An alternative sorting and display method is illustrated in FIG. 4. As seen in this Figure, each shelf 420, 430, 440 can list issues from a given time period, e.g., today, yesterday, last week, etc., with items sorted alphabetically on within each shelf.

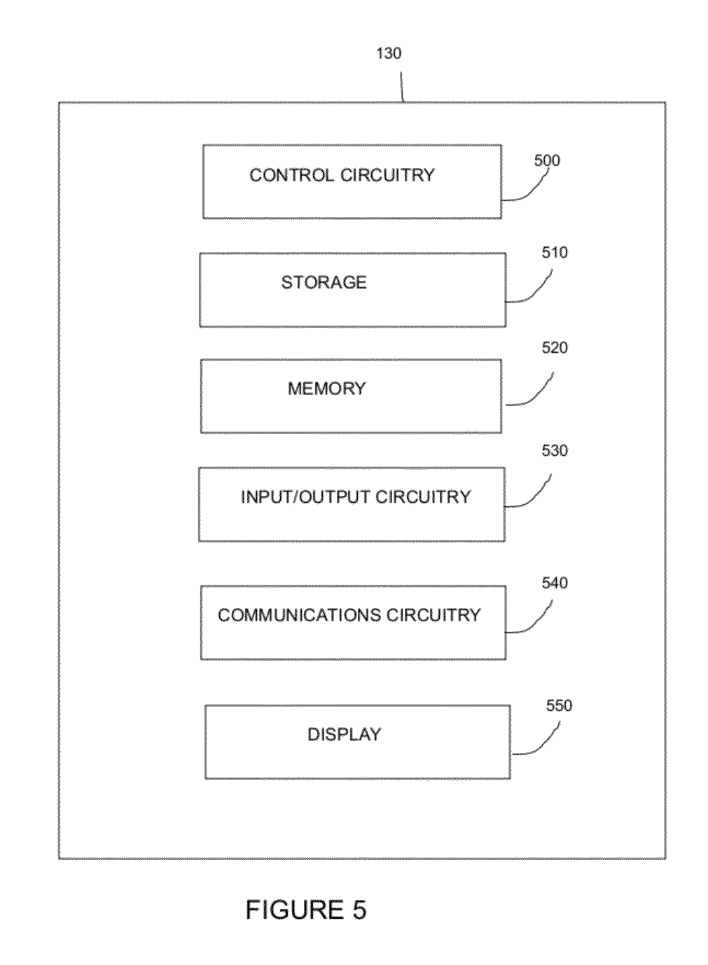

FIG. 5 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in FIG. 5 e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Storage 510 can include, for example, one or more storage mediums including a hard-drive, solid state drive, flash memory, permanent memory such as ROM, any other suitable type of storage component, or any combination thereof. Storage 510 can store, for example, media content, e.g., eBooks, music and video files, application data, e.g., software for implementing functions on electronic device 130, firmware, user preference information data e.g., content preferences, authentication information, e.g. libraries of data associated with authorized users, transaction information data, e.g., information such as credit card information, wireless connection information data. e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, (and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 5 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as for example, a button, keypad, dial, a click wheel, or a touch screen e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VoIP, or any other suitable protocol.

Electronic device 130 can include one more instances of communications circuitry 540 for simultaneously performing several communications operations using different communications networks, although only one is shown in FIG. 5 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for organizing and displaying periodical digital content on a device comprising:
identifying available digital content that is available for use on the device;
determining which available digital content is periodical digital content;
sorting the periodical digital content by title; and
displaying the sorted periodical digital content on the device, each title being displayed on a separate virtual shelf.

2. The method according to claim 1, wherein the act of sorting the periodical digital content by title generates title sorted periodical digital content, the method further comprising:
sorting the title sorted periodical digital content by date,
wherein the act of displaying further comprises displaying the title sorted periodical digital content by date on the respective separate virtual shelves.

3. The method according to claim 1, wherein the act of identifying available digital content further comprises:
identifying available digital content that is stored on the device; and
identifying available digital content that is stored remotely.

4. The method according to claim 1, wherein the act of determining which available digital content is periodical digital content further comprises examining metadata associated with the available digital content, the metadata indicating if the available digital content is periodical digital content.

5. A method for organizing and displaying periodical digital content on a device comprising:
identifying available digital content that is available for use on the device;
determining which available digital content is periodical digital content;
sorting the periodical digital content by date range; and
displaying the sorted periodical digital content on the device by date range, each date range being displayed on a separate virtual shelf.

6. The method according to claim 5, wherein the act of sorting the periodical digital content by date range generates date range sorted periodical digital content, the method further comprising:
sorting the date range sorted periodical digital content by date,
wherein the act of displaying further comprises displaying the date range sorted periodical digital content by date on the respective separate virtual shelves.

7. The method according to claim 5, wherein the act of identifying available digital content further comprises:
identifying available digital content that is stored on the device; and
identifying available digital content that is stored remotely.

8. The method according to claim 5, wherein the act of determining which available digital content is periodical digital content further comprises examining metadata associated with the available digital content, the metadata indicating if the available digital content is periodical digital content.

9. A device for organizing and displaying periodical digital content comprising:
a display;
a memory, the memory storing items of digital content; and
control circuitry coupled to the display and coupled to the memory, the control circuitry operable to:
search the memory and identify available digital content that is available for use on the device,
examine the available digital content and determining which available digital content is periodical digital content,
sort the periodical digital content by title, and
display the sorted periodical digital content on the display, each title being displayed on a separate virtual shelf.

10. The device according to claim 9, further comprising:
communications circuitry coupled to the control circuitry, wherein the control circuitry is operable to direct the communications circuitry to contact a remote server to identify available digital content that is available for use on the device.

11. The device according to claim 9, wherein when the control circuitry sorts the periodical digital content by title it generates title sorted periodical digital content, the control circuitry further operable to:
sort the title sorted periodical digital content by date,
display the title sorted periodical digital content by date on the respective separate virtual shelves.

12. The device according to claim 9, wherein when the control circuitry determines which available digital content is periodical digital content, the control circuitry further operable to examine metadata associated with the available digital content, the metadata indicating if the available digital content is periodical digital content.

13. A device for organizing and displaying periodical digital content comprising:
a display;
a memory, the memory storing items of digital content; and
control circuitry coupled to the display and coupled to the memory, the control circuitry operable to:
search the memory and identify available digital content that is available for use on the device,
examine the available digital content and determining which available digital content is periodical digital content,
sort the periodical digital content by date range, and
display the sorted periodical digital content on the display, each date range being displayed on a separate virtual shelf.

14. The device according to claim 13, further comprising:
communications circuitry coupled to the control circuitry, wherein the control circuitry is operable to direct the communications circuitry to contact a remote server to identify available digital content that is available for use on the device.

15. The device according to claim 13, wherein when the control circuitry sorts the periodical digital content by date range it generates date range sorted periodical digital content, the control circuitry further operable to:
sort the date range sorted periodical digital content by date,
display the date range sorted periodical digital content by date on the respective separate virtual shelves.

16. The device according to claim 13, wherein when the control circuitry determines which available digital content is periodical digital content, the control circuitry further operable to examine metadata associated with the available digital content, the metadata indicating if the available digital content is periodical digital content.
